(19) United States
(12) Patent Application Publication
(10) Pub. No.: US 2015/0342201 A1
(43) Pub. Date: Dec. 3, 2015

(54) STARCH-BASED GLUTEN-FREE BAKED FOODSTUFFS

(71) Applicants: Christopher Thomas, LONG VALLEY, NJ (US); DILEK UZUNALIOGLU, MILLINGTON, NJ (US); ERHAN M. YILDIZ, WHITEHOUSE STATION, NJ (US)

(72) Inventors: Christopher Thomas, LONG VALLEY, NJ (US); DILEK UZUNALIOGLU, MILLINGTON, NJ (US); ERHAN M. YILDIZ, WHITEHOUSE STATION, NJ (US)

(73) Assignee: Corn Products Development, Inc., Sao Paulo (BR)

(21) Appl. No.: 14/294,785

(22) Filed: Jun. 3, 2014

(51) Int. Cl. A21D 13/06; A21D 2/18

(52) U.S. Cl. CPC A21D 13/066; A21D 2/186

(57) ABSTRACT

A composition useful as the principal component in a baked foodstuff is provided. The composition comprises an etherified, non-waxy starch selected from the group consisting of tapioca starch, corn starch, and mixtures thereof, and a native starch selected from the group consisting of corn starch, potato starch, and mixtures thereof. Also provided are compositions useful for preparing baked foodstuffs containing the principal component described above and additionally a minor amount of a non-gluten protein, and a minor amount of a hydrocolloid, and baked foodstuffs prepared by baking such compositions. The baked foodstuffs exhibit extended shelf-life without staling of the baked foodstuff by reason of the use of the compositions described above.

### BACKGROUND OF THE INVENTION

The gluten present in wheat provides a protein structure useful for processing of baked wheat foodstuffs and also provides desirable organoleptic properties. However, in individuals afflicted with celiac disease, consumption of gluten containing food products is not recommended as gluten is considered to generate an undesirable and harmful immune response. Further, many individuals who do not suffer from celiac disease often desire to avoid the consumption of gluten. Thus, there has been a push to develop food items which are gluten free.

WO 2010009464 A1 discloses gluten-free compositions which can be made into a dough to make a gluten-free bread. The dough comprises a gluten-free flour, modified starch, protein, leavening agents, oil and water. It is disclosed that the starch can be physically or chemically modified and states that examples of modified starches include pregelatinized starch, pregelatinized hydroxypropylated starch, cross-linked starch, etherified starch and oxidized starch. The working examples do not specify the nature of the modified starch used therein in an amount of about 1% of the dough formulation.

WO 2010053579 A1 discloses the use of a starch blend that contains corn starch and another starch such that the blend mimics the size characteristics of wheat starch granules to prepare gluten-free bread. One example discloses the inclusion, as an additional ingredient, of a modified tapioca starch in the amount of 5% of the dough formulation.

### SUMMARY OF THE INVENTION

In one aspect, this invention relates to a composition useful as the principal component in a baked foodstuff comprising an etherified, non-waxy starch selected from the group consisting of tapioca starch, corn starch, and mixtures thereof, and a native starch selected from the group consisting of corn starch, potato starch, and mixtures thereof, wherein the etherified non-waxy starch and the native starch provide a composition that if used as the principal component of a gluten-free baked foodstuff, then the baked foodstuff will exhibit crumb firmness of less than about 700 grams average peak force at 14 days after baking.

In another aspect, this invention relates to a composition useful for making a baked foodstuff comprising a major amount of a starch component comprising an etherified, non-waxy starch selected from the group consisting of tapioca starch, corn starch, and mixtures thereof and a native starch selected from the group consisting of corn starch, potato starch, and mixtures thereof, a minor amount of a non-gluten protein, and a minor amount of a hydrocolloid, wherein the etherified non-waxy starch and the native starch provide a composition that if used as the principal component of a gluten-free baked good, then the baked good will exhibit crumb firmness of less than about 700 grams average peak force at 14 days after baking.

In another aspect, this invention relates to a baked foodstuff comprising a major amount of a starch component comprising an etherified, non-waxy starch selected from the group consisting of tapioca starch, corn starch, and mixtures thereof and a native starch selected from the group consisting of corn starch, potato starch, and mixtures thereof, a minor amount of a non-gluten protein, and a minor amount of a hydrocolloid.

It has been found that if an etherified, non-waxy starch selected from the group consisting of tapioca starch, corn starch, and mixtures thereof, is used as the principal component of a dough or batter for a baked foodstuff, then extended shelf-life without staling of the baked foodstuff is obtained as compared to the use of unmodified or physically modified starches. This extended shelf life is achieved under ambient storage conditions, without the use of surfactants, emulsifiers, enzymes or special packaging to extend the shelf life. Thus, preferred compositions consist essentially of the components of the invention, and thus do not otherwise contain anti-staling agents.

As used herein, the terms “major amount” and “minor amount” refer to amounts by weight and are relative to one another. In other words, the terms are used in context relative to one another such that a “major amount” is greater by weight than a “minor amount”.

### DETAILED DESCRIPTION

The principal component of the compositions of the invention is an etherified, non-waxy tapioca or corn starch. Tapioca starch is a starch extracted from manioc (Manihot esculenta). In a typical extraction process, the manioc (after treatment to remove toxicity) is ground to a pulp with a small hand- or diesel-powered mill. This masa is then squeezed to dry it out. The wet masa is placed in a long woven tube. The top of the tube is secured while a large branch or lever is inserted into a loop at the bottom and used to stretch the entire implement vertically, squeezing a starch-rich liquid out through the weave and ends. This liquid is collected and the water allowed to evaporate, leaving behind a fine-grained tapioca powder. Corn starch is the starch derived from the corn (Zea mays) grain. The starch is obtained from the endosperm of the corn kernel, typically by wet milling. In wet milling of corn starch, the kernels are steeped and then roughly ground so that the starch granules can be separated from the corn gluten.

The term “non-waxy starch” as used herein means starch derived from cultivars in which the starch is comprised of both amylose and amylopectin molecules. Non-waxy starch is distinguished from starch from waxy cultivars wherein the starch is essentially free of amylose molecules. The ratio of amylose to amylopectin varies, depending on the source of the starch. Typically, the non-waxy starch will contain at least about 5% by weight amylose, more typically at least about 10% by weight amylose, and even more typically at least about 15% by weight amylose. Corn starch, for example, has around 24% amylose and 76% amylopectin. Tapioca starch only has about 17% amylose.

The native tapioca starch or corn starches are treated with an etherifying agent such as propylene oxide (PO) or ethylene oxide by conventional means. Typically, the starch is slurried in water, adjusted to an alkaline pH and the etherifying agent is then added. The amount of etherifying agent as a percentage by weight of the starch will typically be at least about 1% by weight, more typically at least about 2%, and even more typically at least about 3% by weight. Preferably, the starch will be reacted with from about 3% to about 15% by weight and more typically from about 4% to about 10% by weight of etherifying agent. Optionally, the starch may be cross-linked after etherification, e.g. with phosphorous oxychloride or sodium trimetaphosphate. Typically, the amount of crosslinking will correspond to an amount of phosphorous oxychloride (POCl₃) of from about 0.001% to about 0.05% by weight of the starch. After modification, the starch is typically then adjusted to a slightly alkaline pH and is filtered and dried. The etherified, non-waxy starch will typically be processed in such a manner that the product retains its granular nature. The term “granular starch”, as used herein, means a starch which retains at least part of its granular structure, thereby exhibiting some crystallinity, so that the granules are birefringent and the Maltese cross is evident under polarized light.

The starch compositions of the invention are comprised, in addition to the etherified, non-waxy tapioca or corn starch, of a native potato starch or native corn starch. Potato starch is starch extracted from potatoes. Potatoes are a tuberous crop from the perennial nightshade (Solanum tuberosum). In a typical extraction process, the cells of the root tubers of the potato plant contain starch grains (leucoplasts). To extract the starch, the potatoes are macerated or crushed and the starch grains are released from the destroyed cells. The starch is then washed out, collected, and dried to powder. The potato starch is preferably used in its native state, i.e. as isolated from the cells of the potato and after washing and drying. Preferred compositions of the invention are those in which contain both native potato starch and native corn starch as the native starch component. The native potato and native for starch will also typically be granular. Typically, the weight ratio of native potato starch to native corn starch will range from about 0.5-1.5:1, more typically from about 0.75-1.25:1 and even more typically from about 0.9-1.1:1.

The amounts of etherified, non-waxy tapioca or corn starch and native potato or corn starch in the composition of the invention can vary widely, but the etherified non-waxy tapioca of corn starch will typically constitute more than 40% by weight of the blend, preferably from about 45% to about 75%, and more preferably from about 50% to about 60%. Thus, the weight ratio of etherified, non-waxy tapioca or corn starch to native potato or corn starch will be greater than 0.67:1, preferably from about 0.82:1 to about 3:1, more preferably from about 1:1 to about 1.5:1, and even more preferably from about 1.1:1 to about 1.25:1.

The baked foodstuffs of this invention can be any of a variety of baked goods, including without limitation, gluten-free bread, gluten-free rolls, gluten-free cakes (e.g. angel food cakes, yellow cake, sponge cake, and chiffon cake), gluten-free muffins, gluten-free cookies, and gluten-free pancake and waffle mix.

The baked foodstuff will typically also contain a hydrocolloid. Hydrocolloids are water-dispersible, non-starch hydrophilic materials which are able to increase the viscosity of aqueous systems as a result of their ability to absorb water. Hydrocolloids can be linear or branched and neutral or charged. Suitable hydrocolloids include both naturally occurring gums and synthetic materials. It is considered that in the absence of gluten, the hydrocolloid system helps in holding water in the batter while retaining machinability and holds water in baked product giving it a moist mouth-feel. It is desirable that the amount of hydrocolloid used provides the right viscosity to hold the fermentation gases while expanding in the process. A suitable level for this purpose is up to 5% by weight of the formulation, typically from about 0.1% to about 5% of the formulation, and more typically from about 0.5% to about 3% by weight of hydrocolloid will be used. Examples of suitable hydrocolloids include, but are not limited to, gums such as guar gum, xanthan gum, pectin, locust bean gum, gum acacia, carageenan, konjac, and synthetic materials such as methylcellulose, hydroxypropylmethylcellulose, carboxymethylcellulose, and the like. Also, mixtures of hydrocolloids can be used.

The baked foodstuff will typically also contain a non-gluten protein. Suitable proteins for the present formulation include, but are not limited to, gelatin, soy protein, milk protein, powdered and/or liquid egg whites, egg yolk and whole eggs, and the like. The protein can also be a mixture of proteins. Typically, egg white proteins will be used in place of the gluten. Typically, the dough or batter formulation will contain from about 0.5% to about 3% by weight non-gluten protein, and more typically from about 1% to about 2% by weight non-gluten protein.

The baked foodstuff formulation may also contain a comminuted fiber, e.g. psyllium seed husks. The husks are the outer portions of the seeds of the plant Plantago ovata. Comminuted psyllium seed husks bind moisture and help make breads less crumbly. The husks are dried and chopped, ground, or powdered prior to use in the baked foodstuff formulation.

The baked foodstuff formulation may also comprise leavening agents which can be yeast or chemical leavening agents or combinations thereof. The amount of yeast is about 1 to 6 wt. % of instant dry yeast (or equivalent amounts of other types of yeasts) and all integers and numbers to the tenth decimal place therebetween. In a preferred embodiment, the amount of yeast is about 2-4 wt. %. In various embodiments, the yeast can be about 2.0, 2.5, 3.0, 3.5, 4.0 and all numbers to the tenth decimal point between consecutive recited numbers. Yeast can be purchased and used in different forms. The driest commonly used yeast, sometimes referred to as “instant” yeast, contains about 3.5-6.0% moisture. Cream yeast contains about 80-85% moisture; compressed yeast contains about 66-73% moisture; and active dry yeast contains about 6-8% moisture. Other examples include baker's yeast, protected active dry yeast, frozen yeast and the like. Generally, instant yeast can be used. However, the invention is in no way limited to instant yeast. For a given quantity of instant yeast, one of ordinary skill in the art could easily determine the equivalent amounts of other forms of yeast. For example, 1% compressed yeast is equivalent to about 1.5-1.8% cream yeast, about 0.375-0.5% active dry, and about 0.3125-0.4% instant yeast.

Chemical leavening can be used alone as an alternative to yeast or can be used in combination with yeast. Chemical leavening system includes generally two groups of chemical agents that react to produce a gas that leavens the dough. The two groups of chemical agents are basic component such as baking soda, and acidic components (such as sodium acid phosphate (SAPP) or sodium aluminum phosphate (SALP). The gaseous reaction will occur when the two groups of components come into contact with each other within dough, generally at least in part because one or both groups of the components dissolves in the liquid phase of the dough. Encapsulated chemical leavening agents can be used to control the timing of the gaseous reaction so that no leavening due to the chemical leaveners occurs at room temperature such as during mixing, sheeting or pressing process. The encapsulated leavening agents typically comprise particulates of solid leavening agents coated with a barrier material such as fat or polymer that is solid at room temperature. The solid fat creates a barrier between the chemical leavening agent and the liquid component of the dough composition. When present, the amount of chemical leaveners is between about 0.1 to 1.5 wt. %.

Combinations or yeast and chemical leavening can be used depending upon the desired product. For example, for bread rolls or pizza, yeast alone or yeast in combination with chemical leavening can be used. For flat thin products like tortillas and the like, only chemical leavening can be used. For making a gluten-free all natural product, only yeast is used.

The baked foodstuff formulation of the present invention may also comprise emulsifiers, e.g. in an amount between about 0.1% to about 0.5% by weight. Suitable emulsifiers include mono-, di- or polyglycerides of fatty acids, lecithin, hydroxylated lecithin, calcium or sodium stearoyl lactylates and diacetyl tartaric acid ester of monoglyceride, and/or mixtures thereof. However, emulisfiers are optional and, typically, the baked foodstuff formulation will be essentially free of emulsifiers.

The baked foodstuff formulation will also typically be comprised of other ingredients commonly used in such formulations such as sweeteners, food acids (e.g. cream of tartar, fumaric acid, acetic acid, and citric acid), flavorings such as vanilla, and water. The amount of water in the dough or batter formulation van vary widely, but will typically be from about 20% to about 60% by weight, more typically from about 30% to about 50% by weight of the formulation.

A measure of staling is increasing crumb firmness. The crumb firmness of the baked foodstuffs of the invention will be such that they exhibit less than about 700 grams average peak force at 14 days after baking when tested by the method described below, preferably less than about 650 grams, more preferably less than about 600 grams and even more preferably less than about 550 grams. Preferred baked foodstuffs will exhibit an average peak force at 14 days after baking of from about 75 grams to about 500 grams, and typically from about 100 grams to about 450 grams, and more typically from about 200 grams to about 400 grams. More preferred baked foodstuffs will exhibit the foregoing crumb firmnesses when tested 21 days after baking, and even more preferably when tested 28 days after baking.

The following examples will serve to illustrate the invention and should not be construed to limit the invention, unless otherwise provided in the appended claims.

### EXAMPLES

### Preparation of Crosslinked/Hydroxypropylated Starches

The starches were reacted with propylene oxide (PO) and then cross-linked with phosphorus oxychloride (POCl₃) to result in starches with the desired degree of bound hydroxypropyl groups as well as the desired level of crosslinking. A generalized preparation procedure is given below.

The reaction with propylene oxide was carried out by adding a total of 1000 parts starch to a reaction vessel containing a solution of 180 parts sodium sulfate in 1250 parts water. To this solution, 1.3 parts of sodium hydroxide (added as a 3% solution) was added to provide an alkalinity of 64 mL (mL 0.1 N HCl required to neutralize 50 mL of slurry), followed by addition of propylene oxide under a nitrogen atmosphere. This slurry was allowed to react at 40° C. while being continuously agitated to assure uniform suspension of the starch throughout the mixture. After 16 hours the temperature was reduced to 30° C. POCl₃ was then added at the desired level on starch weight and allowed to react for 30 minutes. The pH of the resultant suspension was then adjusted to 3.0-3.5 with 25% sulfuric acid solution, held for 1 hour and then adjusted to pH 5.5 by the addition of 3% NaOH. The hydroxypropylated and cross-linked starch was then recovered by filtration, washed with 1000 parts water, and dried. The amount of propylene oxide and phosphorus oxychloride were varied to achieve the intended substitution levels shown in Table 1 below.

TABLE 1

| Starch | | PO | POCl₃ |
|---|---|---|---|
| No. | Base | wt. % | wt. % |
| 1 | Tapioca | 7.5 | 0.01 |
| 2 | Tapioca | 5.2 | 0.001 |
| 3 | Tapioca | 7.0 | 0 |
| 4 | Tapioca | 6.0 | 0.011 |
| 5 | Tapioca | 4.5 | 0.005 |
| 6 | Tapioca | 4.8 | 0.016 |
| 7 | Corn | 8.2 | 0.0055 |
| 8 | Waxy Corn | 8.5 | 0.004 |
| 9 | Native | 0 | 0 |
| | Sago | | |
| 10 | Native | 0 | 0 |
| | Tapioca | | |
| 11 | Tapioca¹ | 0 | 0 |

¹Dry thermally inhibited, Novation 3300 ® starch, Ingredion Incorporated, Bridgewater, New Jersey

### Procedure for Making Gluten-Free White Bread:

Gluten-free white bread was prepared in a 3-speed Hobart mixer, using the hook attachment. (Part A) HFCS dispersed in room temperature water (77° F.). Added instant yeast and psyllium husk to water solution and whisked to disperse psyllium and prevent lumping. Let mixture stand for 1.5 minutes to allow for hydration of psyllium husk. (Part B) All dry ingredients, except for instant yeast, pre-blended prior to addition to mixing. Added pre-blended dry ingredients on top of water/syrup/psyllium husk/yeast mixture. Added canola oil on top of dry ingredients. Mixed with dough hook on low speed on planetary mixer until all dry ingredients had been incorporated into dough. Scaled dough to 520 g to achieve final bake weight of 454 g. Rounded dough by hand and molded using Glimek Bread Molder and placed in greased bread loaf pans. Proofed at 95° F. and 85% RH for 60 to 90 minutes, until dough rose 1 inch above the rim of loaf pan. Baked bread loaf at 204° C. (400° F.) for approximately 30 minutes in MIWE Deck Oven, with one steam addition at beginning of baking process. Cooled baked loaves for at least 1 hour or until completely cooled. Packaged cooled loaves into 2 mil polyethylene bread bags (8″×4″×16″), closed with metal twist ties and placed into freezer.

The various test starches were used to prepare breads as set forth above in the formulation set forth in Table 2.

TABLE 2

| | Ingredients | Bakers wt. % | True wt. % |
|---|---|---|---|
| Part A | High Fructose Corn | 5.09 | 2.09 |
| | Syrup - 42% | | |
| | Water | 99.98 | 41.13 |
| | Psyllium Husk | 5.84 | 2.40 |
| | Yeast, Instant | 1.63 | 0.67 |
| Part B | Test Starch | 54.00 | 22.21 |
| | Corn Starch¹ | 23.00 | 9.46 |
| | Potato Starch² | 23.00 | 9.46 |
| | Granulated Sugar | 8.27 | 3.40 |
| | Egg White Powder | 3.74 | 1.54 |
| | Hydroxypropylmethyl | 4.06 | 1.67 |
| | Cellulose³ | | |
| | Salt | 2.04 | 0.84 |
| | Calcium Propionate | 0.30 | 0.12 |
| | Canola Oil | 12.19 | 5.01 |
| Total | | 243.14 | 100.00 |

¹Native corn starch, MELOJEL ®starch, Ingredion Incorporated, Bridgewater, New Jersey
²Native Potato Starch, Avebe NS-450, Avebe, Veendam, The Netherlands
³HPMC, Benecel K4M, Ashland, Inc. Covington, Kentucky

### Crust and Crumb Color Testing:

Bread loaves thawed overnight. Calibrated portable colorimeter (Konica-Minolta CR-410) used to measure L*, a*, b* values of bread crust and crumb (bread interior). Crust color measurement taken on sample crust surface prior to slicing. After bread was sliced, a measurement of crumb color was taken.

### AIB Bread Scoring:

Bread samples evaluated using AIB bread scoring method, where scores are given for dough, external and internal attributes. Dough is scored out of mixer (10), at make-up (10) and out of proofer (7) for a maximum total score of 27. External bread characteristics evaluated include symmetry (5), crust character (5), crust color (5) and break & shred for a maximum total score of 18. Internal bread characteristics evaluated include grain (20), texture (5), crumb body, crumb color, taste/aroma (10) and mouthfeel (10) for a maximum score of 55. Maximum total score is 100.

### Analysis of Crumb Firmness (Bread Interior):

Firmness of bread samples was measured using TA-XTPlus (Stable Microsystems). AIB White Pan Bread Firmness test method chosen from sample projects available in TA-XTPlus database.

AIB White Pan Bread Firmness TA-XTPlus settings:
Mode: Measure force in compression
Option: Return to start
Pre-test speed: 2.0 mm/s
Test speed: 1.7 mm/s
Post-test speed: 10.0 mm/s
Distance: 6.2 mm
Trigger type: Auto
Force: 10 g
Acquisition: 200 pps
Accessory: 25 mm probe

Sample preparation: Breads thawed overnight prior to day 1 measurement. Once thawed, samples were held at ambient conditions. Samples tested on days 1, 8, 15 and 22. On each testing date, 1 loaf of each variable is sliced and measured. Two slices of bread are stacked (starting with slice 4 from the end) for each measurement (4 to 5 measurements per loaf). For each measurement, a maximum peak force value is identified and peak force average and standard deviation for the sample are calculated.

### Examples 1-7 and Comparative Examples A-D

Starches 1 through 11 were used in the formulation shown in Table 2 to prepare and test breads according to the procedures set forth above. The results are set forth in Tables 3-5, below.

TABLE 3

| | | | | | Bread | Bread | | Crust | Crumb |
|---|---|---|---|---|---|---|---|---|---|
| | Starch | | PO | POCl₃ | Height | Weight | Yield | Color | Color |
| Example | No. | Base | wt. % | wt. % | (in.) | (g) | (%) | (L*) | (L*) |
| 1 | 1 | Tapioca | 7.5 | 0.01 | 3.60 | 451.53 | 86.83 | 40.80 | 85.45 |
| 2 | 2 | Tapioca | 5.2 | 0.001 | 3.08 | 461.08 | 88.67 | 46.56 | 85.15 |
| 3 | 3 | Tapioca | 7.0 | 0 | 3.17 | 459.34 | 88.33 | 36.80 | 86.05 |
| 4 | 4 | Tapioca | 6.0 | 0.011 | 3.11 | 458.91 | 88.25 | 46.94 | 85.91 |
| 5 | 5 | Tapioca | 4.5 | 0.005 | 3.46 | 455.32 | 87.56 | 40.46 | 85.90 |
| 6 | 6 | Tapioca | 4.8 | 0.016 | 3.92 | 453.33 | 87.18 | 42.10 | 88.65 |
| 7 | 7 | Corn | 8.2 | 0.0055 | 3.46 | 459.36 | 88.34 | 40.24 | 86.51 |
| A | 8 | Waxy | 8.5 | 0.004 | 2.67 | 467.21 | 89.85 | 48.85 | 83.37 |
| | | Corn | | | | | | | |
| B | 9 | Native | 0 | 0 | 4.48 | 452.2 | 86.96 | 43.30 | 86.74 |
| | | Sago | | | | | | | |
| C | 10 | Native | 0 | 0 | 3.92 | 452.2 | 87.00 | 43.56 | 83.35 |
| | | Tapioca | | | | | | | |
| D | 11 | Tapioca¹ | 0 | 0 | 4.40 | 451.1 | 86.75 | 35.78 | 86.88 |

¹Dry thermally inhibited, Novation 3300 ® starch, Ingredion Incorporated, Bridgewater, New Jersey

TABLE 4

| | Starch | | PO | POCl₃ | Dough | External | Internal | Total |
|---|---|---|---|---|---|---|---|---|
| Example | No. | Base | wt. % | wt. % | Score | Score | Score | Score |
| 1 | 1 | Tapioca | 7.5 | 0.01 | 17 | 15 | 44 | 76 |
| 2 | 2 | Tapioca | 5.2 | 0.001 | 17 | 11 | 39 | 67 |
| 3 | 3 | Tapioca | 7.0 | 0 | 18 | 11 | 40 | 69 |
| 4 | 4 | Tapioca | 6.0 | 0.011 | 17 | 13 | 41 | 71 |
| 5 | 5 | Tapioca | 4.5 | 0.005 | 16 | 13 | 43 | 72 |
| 6 | 6 | Tapioca | 4.8 | 0.016 | 15 | 14 | 45 | 74 |
| 7 | 7 | Corn | 8.2 | 0.0055 | 18 | 14 | 44 | 76 |
| A | 8 | Waxy | 8.5 | 0.004 | 19 | 11 | 40 | 70 |
| | | Corn | | | | | | |
| B | 9 | Native | 0 | 0 | 14 | 13 | 34 | 61 |
| | | Sago | | | | | | |
| C | 10 | Native | 0 | 0 | 17 | 14 | 37 | 68 |
| | | Tapioca | | | | | | |
| D | 11 | Tapioca¹ | 0 | 0 | 14 | 12 | 40 | 66 |

¹Dry thermally inhibited, Novation 3300 ® starch, Ingredion Incorporated, Bridgewater, New Jersey

TABLE 5

| | | | | | Crumb Firmness | | | |
|---|---|---|---|---|---|---|---|---|
| | | | | | Peak Force Avg. (g) | | | |
| | Starch | | PO | POCl₃ | | | Day | Day |
| Example | No. | Base | wt. % | wt. % | Day 1 | Day 8 | 15 | 22 |
| 1 | 1 | Tapioca | 7.5 | 0.01 | 159.57 | 218.85 | 335.06 | 496.81 |
| 2 | 2 | Tapioca | 5.2 | 0.001 | 159.95 | 461.16 | 589.29 | 824.02 |
| 3 | 3 | Tapioca | 7.0 | 0 | 134.58 | 180.71 | 241.15 | 349.56 |
| 4 | 4 | Tapioca | 6.0 | 0.011 | 274.49 | 299.58 | 536.03 | 516.96 |
| 5 | 5 | Tapioca | 4.5 | 0.005 | 172.40 | 205.26 | 479.15 | 585.19 |
| 6 | 6 | Tapioca | 4.8 | 0.016 | 225.34 | 244.50 | 340.51 | 444.36 |
| 7 | 7 | Corn | 8.2 | 0.0055 | 304.72 | 434.73 | 639.58 | 705.86 |
| A | 8 | Waxy | 8.5 | 0.004 | 530.22 | 1127.36 | 1433.95 | 1855.14 |
| | | Corn | | | | | | |
| B | 9 | Native | 0 | 0 | 620.69 | 761.98 | 795.89 | 874.27 |
| | | Sago | | | | | | |
| C | 10 | Native | 0 | 0 | 853.03 | 894.51 | 964.16 | 1164.26 |
| | | Tapioca | | | | | | |
| D | 11 | Tapioca¹ | 0 | 0 | 858.01 | 1040.32 | 1068.85 | 2375.83 |

¹Dry thermally inhibited, Novation 3300 ® starch, Ingredion Incorporated, Bridgewater, New Jersey

### Conclusions:

Gluten-free white bread comprised of a starch blend of the invention has superior shelf stability over the comparative starch blends. A shelf life of a minimum 14 days can be achieved with the blends of this invention. When comparative starch blends are substituted for the starch blends of the invention, the bread firmness scores start high and rapidly escalate, indicative of a fast rate of staling.

### Examples 8-10

Example 1 was repeated was repeated three times, except that each time, a different commercially available native potato starch was substituted for the Avebe NS-450 potato starch. The three native potato starches were:

TABLE 6

| Potato | | |
|---|---|---|
| Starch No. | Starch Name and Manufacturer | Description |
| 1 | FARINA Potato Starch, available from | Native potato starch |
| | Ingredion EMEA, 10 Finderne Ave., | |
| | Bridgewater, New Jersey | |
| 2 | Bob's Red Mill Potato Starch, Bob's | Native potato starch |
| | Red Mill Natural Foods, Milwaukie, | |
| | Oregon | |
| 3 | Westarch 100, available from | Native potato starch |
| | Western Polymer, Moses Lake, | |
| | Washington | |

The properties of breads made using these three commercial potato starches in place of the Avebe NS 450 potato starch are shown in Tables 7-9, below, along with the properties of the bread of Example 1.

TABLE 7

| | Potato | Bread | Bread | | Crust | Crumb |
|---|---|---|---|---|---|---|
| | Starch | Height | Weight | Yield | Color | Color |
| Example | No. | (in.) | (g) | (%) | (L*) | (L*) |
| 1 | (Avebe) | 3.60 | 451.53 | 86.83 | 40.80 | 85.45 |
| 8 | 1 | 3.56 | 454.91 | 87.48 | 38.34 | 87.04 |
| 9 | 2 | 3.52 | 452.51 | 87.02 | 41.38 | 87.34 |
| 10 | 3 | 3.81 | 455.77 | 87.65 | 38.93 | 87.62 |

TABLE 8

| | Potato | Dough | External | Internal | Total |
|---|---|---|---|---|---|
| Example | Starch No. | Score | Score | Score | Score |
| 1 | (Avebe) | 17 | 15 | 44 | 76 |
| 8 | 1 | 19 | 14 | 43 | 76 |
| 9 | 2 | 19 | 13 | 41 | 73 |
| 10 | 3 | 17 | 15 | 41 | 73 |

TABLE 9

| | | Crumb Firmness | | | |
|---|---|---|---|---|---|
| | Potato | Peak Force Avg. (g) | | | |
| Example | Starch No. | Day1 | Day 8 | Day 15 | Day 22 |
| 1 | 1 | 159.57 | 218.85 | 335.06 | 496.81 |
| 2 | 2 | 128.79 | 149.20 | 209.30 | 268.94 |
| 3 | 3 | 141.84 | 184.14 | 255.75 | 278.40 |
| 4 | 4 | 203.44 | 159.95 | 255.75 | 354.71 |

What is claimed is:

1. A composition useful as the principal component in a baked foodstuff comprising an etherified, non-waxy starch selected from the group consisting of tapioca starch, corn starch, and mixtures thereof, and a native starch selected from the group consisting of corn starch, potato starch, and mixtures thereof, wherein the etherified non-waxy starch and the native starch provide a composition that if used as the principal component of a gluten-free baked good, then the baked good will exhibit crumb firmness of less than about 700 grams average peak force at 14 days after baking.

2. The composition of claim 1, wherein the etherified, non-waxy starch contains at least about 5% by weight amylose.

3. The composition of claim 1, wherein the etherified, non-waxy starch contains at least about 15% by weight amylose.

4. The composition of claim 1, wherein the etherified, non-waxy starch is a hydroxypropyl starch.

5. The composition of claim 1, wherein the etherified, non-waxy starch has at least about 1% by weight of ether substitution.

6. The composition of claim 1, wherein the etherified, non-waxy starch has from about 3% to about 15% by weight of ether substitution.

7. The composition of claim 1, wherein the etherified, non-waxy starch is cross-linked.

8. The composition of claim 1, wherein the native starch is a mixture of a native potato starch and a native corn starch.

9. The composition of claim 1, wherein the weight ratio of etherified, non-waxy starch to native starch is greater than about 0.67:1.

10. The composition of claim 1, further comprising a hydrocolloid.

11. The composition of claim 10, wherein the hydrocolloid is present in an amount of from about 0.1% to about 5% by weight of the composition.

12. A composition useful for making a baked foodstuff comprising a major amount of a starch component comprising an etherified, non-waxy starch selected from the group consisting of tapioca starch, corn starch, and mixtures thereof, and a native starch selected from the group consisting of corn starch, potato starch, and mixtures thereof, a minor amount of a non-gluten protein, and a minor amount of a hydrocolloid, wherein the etherified non-waxy starch and the native starch provide a composition that if used as the principal component of a gluten-free baked good, then the baked good will exhibit crumb firmness of less than about 700 grams average peak force at 14 days after baking.

13. The composition of claim 12, wherein the hydrocolloid is present in an amount of from about 0.1% to about 5% by weight of the composition.

14. The composition of claim 12, wherein the hydrocolloid is selected from the group consisting of methylcellulose, hydroxypropylmethylcellulose, and carboxymethylcellulose.

15. The composition of claim 12, wherein the hydrocolloid is hydroxypropylmethylcellulose.

16. The composition of claim 12, wherein the non-gluten protein is egg albumen.

17. A baked foodstuff comprising a major amount of a starch component comprising an etherified, non-waxy starch selected from the group consisting of tapioca starch, corn starch, and mixtures thereof, and a native starch selected from the group consisting of corn starch, potato starch, and mixtures thereof, a minor amount of a non-gluten protein, and a minor amount of a hydrocolloid, wherein the etherified non-waxy starch and the native starch provide a composition that if used as the principal component of a gluten-free baked good, then the baked good will exhibit crumb firmness of less than about 700 grams average peak force at 14 days after baking.

18. A baked foodstuff of claim 17, wherein the baked good will exhibit crumb firmness of less than about 700 grams average peak force at 21 days after baking.

19. A baked foodstuff of claim 17, wherein the baked good will exhibit crumb firmness of less than about 700 grams average peak force at 28 days after baking.

20. A composition useful for making a baked foodstuff comprising a major amount of a starch component comprising a hydroxypropylated, non-waxy starch selected from the group consisting of tapioca starch, corn starch, and mixtures thereof, said hydroxypropylated, non-waxy starch having from about 3% to about 15% by weight of hydroxypropyl substitution, and a native starch selected from the group consisting of corn starch, potato starch, and mixtures thereof, wherein the weight ratio of etherified, non-waxy starch to native starch is greater than about 0.67:1, and a minor amount of a hydrocolloid.
